(19) United States
(12) Patent Application Publication
(10) Pub. No.: US 2018/0004064 A1
(43) Pub. Date: Jan. 4, 2018

(54) STABILIZER FOR CAMERA SHOOTING

(71) Applicant: Yehong Production, Seoul (KR)

(72) Inventor: Do Hun KIM, Seoul (KR)

(73) Assignee: Yehong Production, Seoul (KR)

(21) Appl. No.: 15/472,328

(22) Filed: Mar. 29, 2017

(30) Foreign Application Priority Data
Jul. 1, 2016 (KR) 10-2016-0083534

(51) Int. Cl. G03B 5/00; F16M 13/02; G03B 17/56; G02B 27/64

(52) U.S. Cl. CPC G03B 5/00; G02B 27/646; F16M 13/022; G03B 17/561; F16M 2200/04; G03B 2205/0007

(57) ABSTRACT

A stabilizer for camera shooting, which enables correction of a position of a camera module, includes a frame having an inner space, a plurality of camera modules mounted on the frame, each of the plurality of camera modules including a lens for shooting an outside of the frame, a first brushless motor arranged in the inner space and rotating the frame around a first rotation axis, and a second brushless motor arranged in the inner space and rotating the frame around a second rotation axis crossing the first rotation axis on a same plane, in which the frame is rotatably coupled to the first brushless motor via a first shaft, the frame capable of rotating with respect to the first brushless motor, and a height of each lens in a Z-axis direction is within a range of a shortest dimension in a transverse direction between the frame and a center of the inner space of the frame with respect to the first shaft.

### CROSS-REFERENCE TO RELATED APPLICATION

This application claims the benefit of Korean Patent Application No. 10-2016-0083534, filed on Jul. 1, 2016, in the Korean Intellectual Property Office, the disclosure of which is incorporated herein in its entirety by reference.

### BACKGROUND

### 1. Field

One or more embodiments relate to a stabilizer for camera shooting, and more particularly, to a stabilizer for camera shooting in which a camera module is provided outside a frame and a brushless motor for correcting a position of the camera module is provided in an inner space of the frame, so that an error between the brushless motor and the camera module may be reduced.

### 2. Description of the Related Art

In general, similar to an actual environment, virtual reality (VR) is a three-dimensional (3D) virtual environment which is manufactured by using computer graphics technologies to provide a 3D virtual space to a participant. Recently, such VR has been implemented by camera shooting. A VR image is completed by capturing images using a camera moving around 360 degrees and up and down, processing and stitching the captured images, and mapping a processed image to a spherical or cylindrical shape.

A user may see the VR image by rotating, enlarging, reducing, or moving an image around a shooting position. In other words, the user may rotate and move the image to a point the user wants to see, or may view the image by enlarging the same.

To manufacture a VR image by using a camera, the camera needs to shoot images around 360 degrees and up and down. A camera gimbal as illustrated in FIG. 1 has been conventionally used to manufacture a VR image.

Referring to FIG. 1, the conventional camera gimbal device may include a yaw-axis motor 10, a pitch-axis motor 20, a roll-axis motor 30, a camera 40, and a support rod 50. In general, camera gimbal devices may be used by being connected to unmanned aerial vehicles or drones, or a user may directly use a camera gimbal device to capture images. When the camera 40 is shaken during shooting, camera images may not be constant, and thus the yaw-axis motor 10, the pitch-axis motor 20, and the roll-axis motor 30 are used to maintain a camera level.

The yaw-axis motor 10, the pitch-axis motor 20, and the roll-axis motor 30 are provided with sensors for sensing shaking of the camera gimbal device. According to a degree of shaking of the device, the yaw-axis motor 10, the pitch-axis motor 20, and the roll-axis motor 30 rotate the camera 40 respectively around a Z-axis, an X-axis, and the Y-axis, thereby adjusting the position of the camera 40.

The camera 40 of the conventional camera gimbal device is mounted at the lowermost end of the support rod 50. In general, for a camera gimbal device, an upper portion of the camera gimbal device is connected to an unmanned aerial vehicle or a drone, or a user holds the upper portion of the camera gimbal device for shooting. In the case of the camera 40 that shoots while moving around 360 degrees and up and down, when the camera 40 is located close to an unmanned aerial vehicle, a drone, or a human, the unmanned aerial vehicle, drone, or human is included in a captured image. However, when a VR image is manufactured, such an image should be excluded. Accordingly, the above unnecessary images are excluded, if possible. To this end, the camera 40 is lowered down to the lowermost end of the support rod 50 before shooting is performed.

However, when the camera 40 is lowered to the lowermost end, a problem may be generated in the adjustment of the position of the camera 40. As the camera 40 is located at the lowermost end, an error may occur between shaking sensed by the yaw-axis motor 10, the pitch-axis motor 20, and the roll-axis motor 30 and shaking actually generated in the camera 40 at the lowermost end. The shaking generated in the yaw-axis motor 10, the pitch-axis motor 20, and the roll-axis motor 30 gradually increases toward the lower end of the support rod 50. In other words, the size of shaking generated at a particular position increases as a distance of the particular position from an uppermost end of the camera gimbal device increases. According to the above phenomenon, the shaking generated in the camera 40 provided at the lowermost end is increased relative to the shaking sensed by the yaw-axis motor 10, the pitch-axis motor 20, and the roll-axis motor 30.

Accordingly, an error may be generated between the shaking sensed by the yaw-axis motor 10, the pitch-axis motor 20, and the roll-axis motor 30 and the shaking actually generated in the lowermost end of the camera 40. The error may increase as the camera 40 is located farther from the yaw-axis motor 10, the pitch-axis motor 20, and the roll-axis motor 30. Such an error may create difficulty in manufacturing a VR image in the conventional camera gimbal device.

Furthermore, when the camera 40 and other devices are mounted at the lowermost end, the center of gravity of the camera gimbal device is located at a lower end. Accordingly, a problem of shaking in the camera gimbal device may become severe.

The present invention was invented by performing a national research and development project (Project No.: R2016080022, Name of Dept.: Ministry of Culture, Sports and Tourism, Research Management Agency: Korea Creative Content Agency, Research Business Name: Culture Technology Research and Development Support Business, Research Project Name: Development of Camera Posture Control Technology For High-Resolution Actual VR Image Contents, Main Agency: Yehong Production Co., Ltd., Research Period: 2016 Nov. 1-2017 Aug. 31).

### SUMMARY

One or more embodiments include a stabilizer for camera shooting, in which a camera module is provided outside a frame, and a brushless motor for correcting a position of the camera module is provided in an inner space of the frame so that an error between the brushless motor and the camera module may be reduced.

Additional aspects will be set forth in part in the description which follows and, in part, will be apparent from the description, or may be learned by practice of the presented embodiments.

According to one or more embodiments, a stabilizer for camera shooting, which enables correction of a position of a camera module, includes a frame having an inner space, a plurality of camera modules mounted on the frame, each of the plurality of camera modules including a lens for shooting an outside of the frame, a first brushless motor arranged in the inner space and rotating the frame around a first rotation axis, and a second brushless motor arranged in the inner space and rotating the frame around a second rotation axis crossing the first rotation axis on a same plane, in which the frame is rotatably coupled to the first brushless motor via a first shaft, the frame capable of rotating with respect to the first brushless motor, and a height of each lens in a Z-axis direction is within a range of a shortest dimension in a transverse direction between the frame and a center of the inner space of the frame with respect to the first shaft.

The stabilizer for camera shooting may further includes an orthogonal frame extending upward in the Z-axis direction with respect to the frame, and a third brushless motor mounted on the orthogonal frame and rotating the frame around a third rotation axis crossing the first rotation axis and the second rotation axis on a plane different from a plane formed by the first rotation axis and the second rotation axis.

The stabilizer for camera shooting may include a fixed frame arranged in the inner space and to which the first brushless motor is fixed, in which the fixed frame is coupled to the second brushless motor via a second shaft, the fixed frame capable of rotating with respect to the second brushless motor, the second brushless motor is fixed to the orthogonal frame, and the orthogonal frame is rotatably coupled to the third brushless motor via a third shaft.

The lens may be formed on a same plane as the first shaft or the second shaft, or the lens may be formed on a same plane as the first shaft and the second shaft.

The orthogonal frame or the third shaft may be capable of contracting and expanding in a lengthwise direction of the third shaft.

The stabilizer for camera shooting may further include a damper plate, the damper plate including a fixed member to which the third brushless motor is fixed, a first plate coupled to the fixed member and having a plurality of first coupling holes, a second plate spaced apart from the first plate in the Z-axis direction and having a plurality of second coupling holes, and an elastic member inserted in each of the plurality of first coupling holes and each of the plurality of second coupling holes to connect the first plate and the second plate.

The stabilizer for camera may further include a support rod connected to the damper plate.

The stabilizer for camera shooting may further include a balance weight detachably coupled to the stabilizer for camera shooting.

The stabilizer for camera may further include a lower frame extending downward from the frame in the Z-axis direction, in which the camera module is mounted on the frame and the lower frame, and the lens of the camera module mounted on the lower frame captures an image of ground.

### BRIEF DESCRIPTION OF THE DRAWINGS

These and/or other aspects will become apparent and more readily appreciated from the following description of the embodiments, taken in conjunction with the accompanying drawings in which:

FIG. 1 illustrates a conventional camera gimbal device;

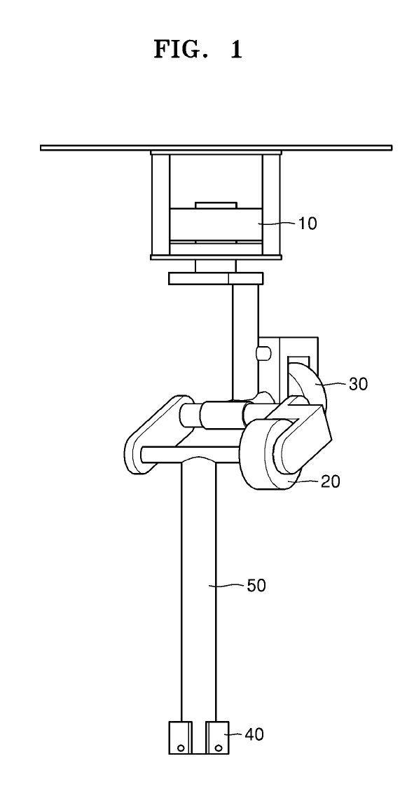

FIG. 2 is a perspective view of a stabilizer for camera shooting according to an embodiment;

FIG. 3 is a bottom view of the stabilizer for camera shooting of FIG. 2;

FIG. 4 is a side view of the stabilizer for camera shooting of FIG. 2;

FIG. 5 illustrates a range of a shortest dimension in a transverse direction between a center of an inner space of a frame and the frame, according to an embodiment;

FIG. 6 illustrates contraction and expansion of an orthogonal frame, according to an embodiment;

FIG. 7 illustrates that a support rod is connected to the stabilizer for camera shooting of FIG. 2;

FIG. 8 is a perspective view of a stabilizer for camera shooting according to another embodiment; and

FIG. 9 is a bottom view of the stabilizer for camera shooting of FIG. 8.

### DETAILED DESCRIPTION

Reference will now be made in detail to embodiments, examples of which are illustrated in the accompanying drawings, wherein like reference numerals refer to like elements throughout. In this regard, the present embodiments may have different forms and should not be construed as being limited to the descriptions set forth herein. Accordingly, the embodiments are merely described below, by referring to the figures, to explain aspects of the present description. As used herein, the term “and/or” includes any and all combinations of one or more of the associated listed items. Expressions such as “at least one of,” when preceding a list of elements, modify the entire list of elements and do not modify the individual elements of the list.

The present disclosure relates to a stabilizer for camera shooting, in which a camera module is provided outside a frame and a brushless motor for correcting a position of the camera module is provided in an inner space of the frame so that an error between the brushless motor and the camera module may be reduced. Hereinafter, embodiments of the present disclosure will be described in detail with reference to the accompanying drawings.

According to the present disclosure, a stabilizer 100 using a brushless motor capable of correcting a position of a camera may include a frame 110, a camera module 120, a first brushless motor 130, and a second brushless motor 140.

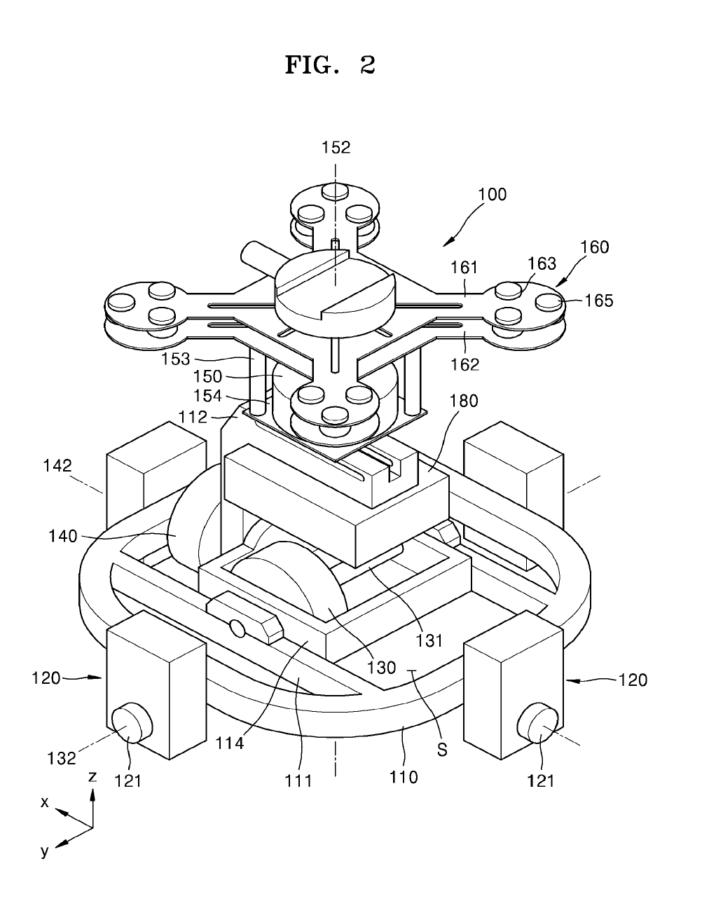

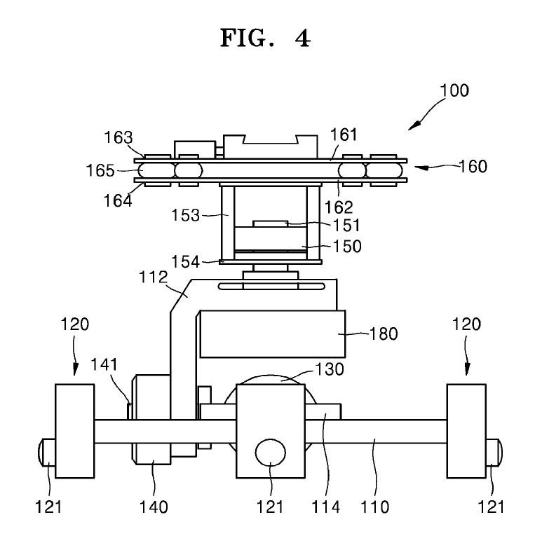

Referring to FIGS. 2 to 4, the frame 110 is provided with an inner space S. The frame 110 may have various shapes such as a circle, a rectangle, a pentagon, etc. When the frame 110 has a circular shape, the frame 110 may have partially linear portions. A support frame 111 may be provided in the inner space S of the frame 110 to reinforce strength of the frame 110 and provide a mounting position at which the first brushless motor 130 provided in the inner space S may be mounted.

The camera module 120 is mounted on the frame 110, and a lens 121 for capturing images of the outside of the frame 110 is provided on the camera module 120. The camera module 120 may be mounted along an outer circumference of the frame 110 and more than one of the camera module 120 may be provided. The camera module 120 may be provided such that two, three, four, five, six, or more, if necessary, camera modules may be mounted on the frame 110.

The camera module 120 and the stabilizer 100 may be mounted such that they are capable of sliding in four directions with respect to the frame 110 to maintain an overall center of gravity, for convenience of shooting. When the center of gravity of the stabilizer 100 deviates, the camera module 120 may partially and slidably move, thereby adjusting the center of gravity of the stabilizer 100. The lens 121 of the camera module 120 is provided facing the outside of the frame 110 so as to be capable of shooting. The lens 121 for capturing images around 360 degrees and up and down may be provided such that an angle of the lens 121 is adjustable, if necessary.

The camera module 120 may be provided with circuits that store or transmit the images captured by the lens 121. The circuits for storing or transmitting the images captured by the lens 121 may be provided in a space separate from the camera module 120. However, the camera module 120 is not limited thereto and may be formed in various ways. For example, the camera module 120 may be formed of the lens 121 only. In this case, the lens 121 is mounted directly on the frame 110, and a circuit for operating the lens 121 may be arranged at a position other than a position on the frame 110, by being connected to the lens 121 by a cable.

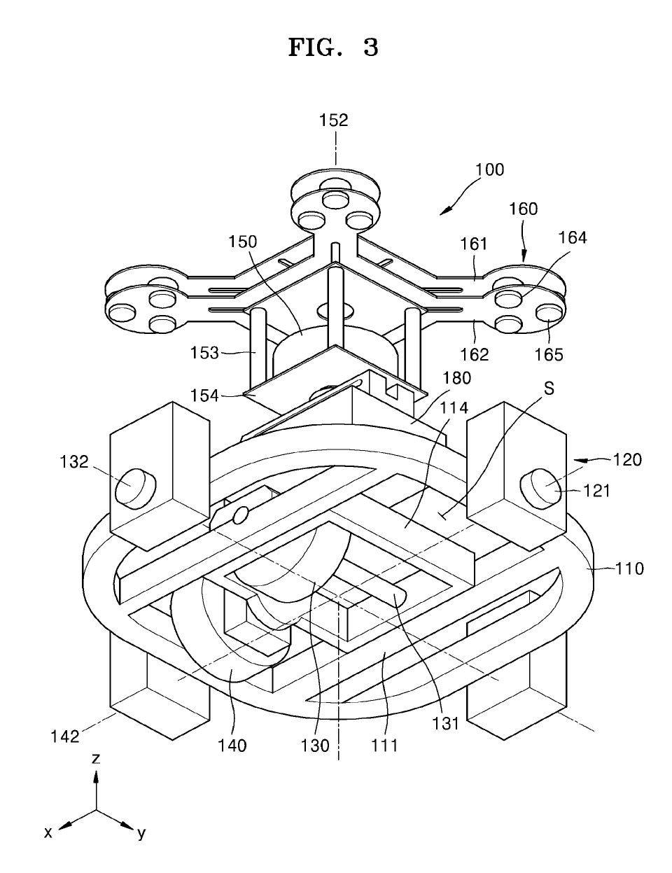

The first brushless motor 130 may be arranged in the inner space S of the frame 110 and may rotate the frame 110 around a first rotation axis 132. As the first brushless motor 130 rotates the frame 110 around the first rotation axis 132, the lens 121 of the camera module 120 mounted on the frame 110 may be rotated around the first rotation axis 132. In this state, the first rotation axis 132 is parallel to the frame 110. Referring to FIGS. 2 and 3, the first rotation axis 132 may be a Y-axis around which the frame 110 is rotated by the first brushless motor 130.

The second brushless motor 140 is arranged in the inner space S of the frame 110 and may rotate the frame 110 around a second rotation axis 142. As the second brushless motor 140 rotates the frame 110 around the second rotation axis 142, the lens 121 of the camera module 120 mounted on the frame 110 may be rotated around the second rotation axis 142.

In this state, the second rotation axis 142 crosses the first rotation axis 132 on the same plane and is parallel to the frame 110. Referring to FIGS. 2 and 3, the first rotation axis 132 and the second rotation axis 142 perpendicularly cross each other. When the first rotation axis 132 and the second rotation axis 142 perpendicularly cross each other, the first rotation axis 132 is a Y-axis and the second rotation axis 142 is an X-axis. Since the frame 110 is provided parallel to the first rotation axis 132 and the second rotation axis 142, the frame 110 may be provided parallel to a plane formed by the X-axis and the Y-axis.

A third brushless motor 150 may be provided on an orthogonal frame 112 extending upward in a Z-axis direction with respect to the frame 110, and may rotate the frame 110 around a third rotation axis 152. As the third brushless motor 150 rotates the frame 110 around the third rotation axis 152, the lens 121 of the camera module 120 provided in the frame 110 may be rotated around the third rotation axis 152.

In this state, the third rotation axis 152 crosses the first rotation axis 132 and the second rotation axis 142 on a plane different from a plane formed by the first rotation axis 132 and the second rotation axis 142. The third rotation axis 152 may perpendicularly cross the first rotation axis 132 and the second rotation axis 142.

In other words, the first rotation axis 132, the second rotation axis 142, and the third rotation axis 152 may perpendicularly cross one another. In this case, the first rotation axis 132 is the Y-axis, the second rotation axis 142 is the X-axis, the third rotation axis 152 is a Z-axis, and the frame 110 is arranged parallel to a plane formed by the X-axis and the Y-axis.

The orthogonal frame 112 extends upward in a Z-axis direction with respect to the frame 110. The orthogonal frame 112 may extend upward in the Z-axis direction and then extend horizontally. The third brushless motor 150 may be placed on a portion of the orthogonal frame 112 extending horizontally.

A coupling relationship between the frame 110, the first brushless motor 130, the second brushless motor 140, and the third brushless motor 150 is described below in detail.

The frame 110 may be coupled to the first brushless motor 130 via a first shaft 131, and the first brushless motor 130 may rotate the frame 110 around the first rotation axis 132 via the first shaft 131. (The first shaft 131 may be coupled to the support frame 111 provided inside the frame 110.)

The first brushless motor 130 is fixedly mounted on a fixed frame 114 provided in the inner space S of the frame 110. The fixed frame 114 is rotatably coupled to the second brushless motor 140 via a second shaft 141. When the second brushless motor 140 rotates the fixed frame 114 around the second rotation axis 142, the first brushless motor 130 fixed to the fixed frame 114 is also rotated with the fixed frame 114. When the first brushless motor 130 rotates, the frame 110 connected to the first brushless motor 130 is rotated around the second rotation axis 142.

The second brushless motor 140 is fixedly mounted on the orthogonal frame 112, and the orthogonal frame 112 is rotatably coupled to the third brushless motor 150 via a third shaft 151. When the third brushless motor 150 rotates the orthogonal frame 112 around the third rotation axis 152, the second brushless motor 140 fixed to the orthogonal frame 112, the fixed frame 114 coupled to the second brushless motor 140, and the first brushless motor 130 coupled to the fixed frame 114 are rotated together with the orthogonal frame 112. When the first brushless motor 130 is rotated, the frame 110 connected to the first brushless motor 130 is rotated around the third rotation axis 152.

According to the stabilizer 100 for correcting the position of a camera module according to the present disclosure, the first, second, and third brushless motors 130, 140, and 150 detect shaking of the stabilizer 100 through sensors. The first, second, and third brushless motors 130, 140, and 150 sensing the shaking of the stabilizer 100 rotate the frame in a direction opposite to a direction in which the shaking of the stabilizer 100 occurs. Accordingly, the position of the camera module 120 mounted on the frame 110 may be corrected.

The stabilizer 100 may further include a board 180 for sensing and operation of the first, second, and third brushless motors 130, 140, and 150. The board 180 including circuits for sensing and operation of the first, second, and third brushless motors 130, 140, and 150 may be mounted on the orthogonal frame 112. However, the position of the board 180 is not limited thereto and the board 180 may be mounted at various positions, as necessary. The principle of operating the first, second, and third brushless motors 130, 140, and 150 via the board 180 is well known, and thus a detailed description thereof is omitted.

The Z-axis height of the lens 121 provided on the camera module 120 may be the same as the height of the first shaft 131, and further, the height along the Z-axis direction of the lens 121 may be the same as the heights of the first shaft 131 and the second shaft 141. In other words, the lens 121 may be on the same plane as the first shaft 131 or the second shaft 141, and further, the lens 121 may be on the same plane as the first shaft 131 and the second shaft 141.

When a brushless motor and a camera are spaced apart from each other as in the related art, an error occurs between shaking sensed by the brushless motor and shaking generated in the camera such that accurate correction of a position of the camera is difficult. According to the present disclosure, by making the first shaft 131, the second shaft 141, and the lens 121 have the same Z-axis height, the lens 121 and the first and second brushless motors 130 and 140 may be located close to each other, and thus, an error that may occur between the shaking sensed by the brushless motors and the shaking generated in the lens may be reduced.

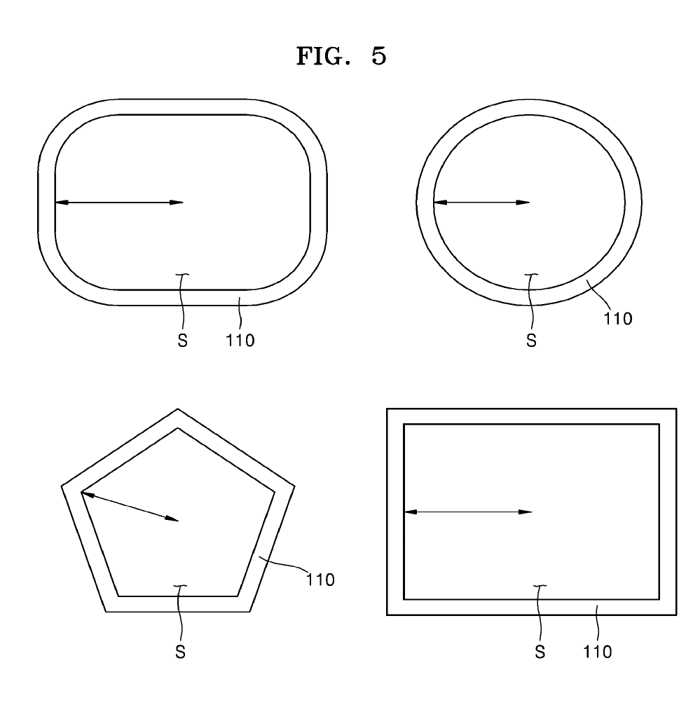

However, the Z-axis height of the lens 121 may be formed so as to be within the range of a shortest dimension in a transverse direction between the center of the inner space S and the frame 110 with respect to the first shaft 131. Referring to FIG. 5, the frame 110 may have various shapes, and the shortest dimension in the transverse direction may be formed between the center of the inner space S and the frame 110.

Although the Z-axis height of the lens 121 is the same as the heights of the first shaft 131 and the second shaft 141, considering the design environment and the shooting position of the lens 121, the Z-axis height of the lens 121 may not be the same as the heights of the first shaft 131 and the second shaft 141. In this case, forming the lens 121 within the range of the shortest dimension with respect to the first shaft 131 may reduce an error range. In other words, the lens 121 may be formed within the range of the shortest dimension in the Z-axis direction with respect to the first shaft 131.

The lens 121 is mounted on the camera module 120 that is provided along the outer circumference of the frame 110. The camera module 120 is spaced apart from the center of the inner space S of the frame 110 in a direction parallel to the plane formed by the X-axis and the Y-axis. A distance between the lens 121 and the center of the inner space S in the direction parallel to the plane formed by the X-axis and the Y-axis may be a distance between the center of the inner space S and the frame 110.

Making the distance between the lens 121 and the center of the inner space S in the Z-axis direction within the distance between the lens 121 and the center of the inner space S in a direction parallel to the plane formed by the X-axis and the Y-axis may reduce the error. Accordingly, the Z-axis height of the lens 121 may be formed within the range of the shortest dimension in the traverse direction between the center of the inner space S and the frame 110 with respect to the first shaft 131.

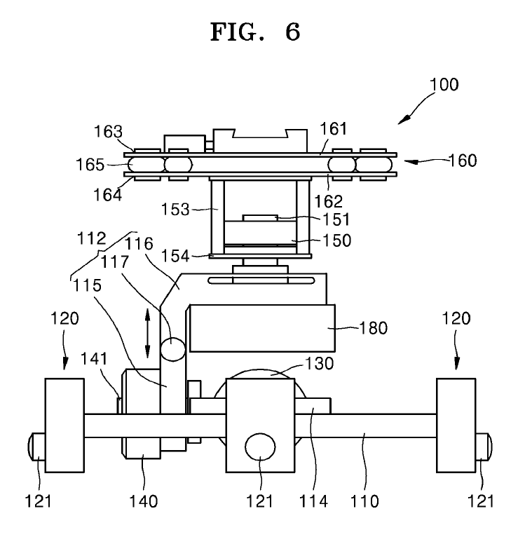

Referring to FIG. 6, the orthogonal frame 112 or the third shaft 151 may be capable of contracting and expanding in a lengthwise direction of the third shaft 151. In other words, the height of the third brushless motor 150 with respect to the frame 110 may be adjusted in the lengthwise direction of the third shaft 151.

The orthogonal frame 112 or the third shaft 151 may be contracted or expanded in the lengthwise direction of the third shaft 151 in various ways. For example, the orthogonal frame 112 includes a lower member 115 and an upper member 116 capable of slidably moving from the lower member 115, and the movement of the upper member 116 may be adjusted by using a fixed screw 117. The third shaft 151 may be adjusted by the same method. However, the method of contracting or expanding the orthogonal frame 112 or the third shaft 151 is not limited thereto and a variety of methods may be employed therefor.

In general, an unmanned aerial vehicle or a drone may be connected to the stabilizer 100 above the third brushless motor 150, or the stabilizer 100 may be used for shooting by being held directly by a user. In this case, when the orthogonal frame 112 or the third shaft 151 is expanded, a portion of an image where an unmanned aerial vehicle, a drone, or a human is captured by the lens 121 may be reduced. The portion of an image where an unmanned aerial vehicle, a drone, or a human is captured may not be used as a captured image and thus may be removed when editing.

The length of the orthogonal frame 112 or the third shaft 151 that contracts or expands may be about 30 cm to about 60 cm. When the orthogonal frame 112 or the third shaft 151 is expanded, the lens 121 may reduce the captured portion of an unmanned aerial vehicle, a drone, or a human. However, when the orthogonal frame 112 or the third shaft 151 is excessively expanded, the center of gravity concentrates at a lower portion of the stabilizer 100. As a position of the center of gravity is lowered, the stabilizer 100 hung on an unmanned aerial vehicle or a drone may be shaken further. Accordingly, the length of the orthogonal frame 112 or the third shaft 151 that contracts or expands may be about 30 cm to about 60 cm.

The third brushless motor 150 may be fixed to a fixed member, and the fixed member may have various shapes. Referring to FIGS. 2 to 4, the fixed member may include a fixed plate 154 coupled to a lower portion of the third brushless motor 150 and a fixed rod 153 extending upward from the fixed plate 154 in the Z-axis direction. The fixed member may fix the third brushless motor 150.

A damper plate 160 may be provided above the third brushless motor 150. The damper plate 160 is coupled to the fixed member and may include a first plate 161 where a plurality of first coupling holes 163 are provided, a second plate 162 spaced apart from the first plate 161 in the Z-axis direction and where a plurality of second coupling holes 164 are provided, and an elastic member 165 inserted in each of the first coupling holes 163 and each of the second coupling holes 164 to connect the first plate 161 and the second plate 162. When the fixed member includes the fixed plate 154 and the fixed rod 153, the second plate 162 is coupled to the fixed rod 153.

The damper plate 160 is a connection portion that connects the stabilizer 100 to an unmanned aerial vehicle or a drone. Furthermore, the damper plate 160 may reduce effects of shaking or vibrations of an unmanned aerial vehicle or a drone through the elastic member 165.

The damper plate 160 includes two plates of the first plate 161 and the second plate 162, and the elastic member 165 is inserted between the two plates. Rubber is generally used for the elastic member 165, and the diameter of the elastic member 165 may be larger than the diameter of each of the first and second coupling holes 163 and 164. The elastic member 165 is forcibly inserted in each of the first and second coupling holes 163 and 164 and fixes the first and second plates 161 and 162. The shaking or vibrations generated in an unmanned aerial vehicle or a drone may be absorbed by using the elasticity of the elastic member 165. In other words, the elastic member 165 functions as a damper for reducing shaking or vibrations.

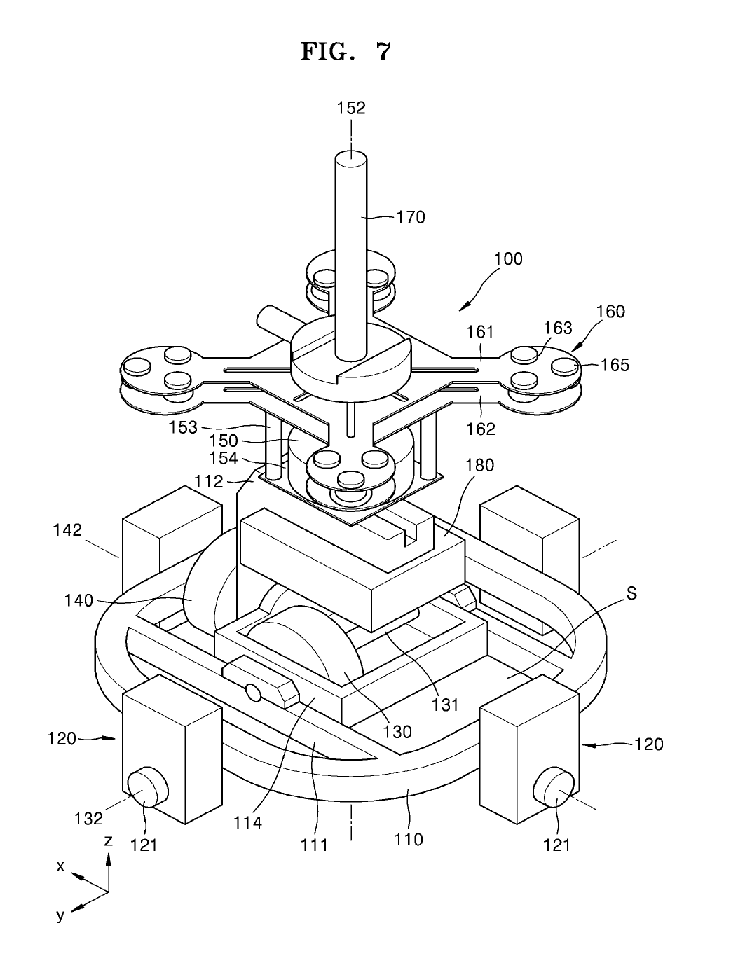

Referring to FIG. 7, a support rod 170 may be connected to an upper portion of the damper plate 160. An unmanned aerial vehicle or a drone may be connected to the damper plate 160 via the support rod 170. The support rod 170 may contract or expand in the lengthwise direction of the third shaft 151. As the support rod 170 contracts or expands like the orthogonal frame 112 or the third shaft 151, the unmanned aerial vehicle or drone may be prevented from being captured by the lens 121.

The support rod 170 may be directly connected to the third brushless motor 150. The damper plate 160 may be used by being connected to the support rod 170. In other words, an arrangement order of the third brushless motor 150-the support rod 170-the damper plate 160 may be available for use, and another arrangement order of the third brushless motor 150-the damper plate 160-the support rod 170 may also be available.

The stabilizer 100 should be kept at a balanced position for shooting. To this end, a balance weight may be provided in the stabilizer 100. The balance weight has a certain weight. The arrangement position of the balance weight is not specified, and the stabilizer 100 may adjust inclination of the stabilizer 100 by placing the balance weight at a position opposite to the inclination direction. A plurality of balance weights having various weights may be provided for use.

The effects of the stabilizer 100 for camera shooting are as follows.

In the camera gimbal device according to the related art, when used for an unmanned aerial vehicle or a drone or used by a human, the camera 40 for shooting is located at the lowermost end to prevent the unmanned aerial vehicle, drone, or human from being captured. However, in the stabilizer 100 for camera shooting according to the present disclosure, shooting is possible by means of the frame 10 where the camera module 120 is mounted, without lowering the camera module 120 to the lowermost end. The frame 110 in the present disclosure may enable the camera module 120 to be arranged so as to be distributed in a direction parallel to the ground. While the camera 40 according to the related art is mounted only in an axial direction so that an image of an unmanned aerial vehicle, a drone, or a human is unavoidably captured due to a shooting angle, the frame 110 according to the present disclosure may solve the above problem due to the camera module 120 being arranged so as to be distributed in a planar direction parallel to the ground.

Furthermore, in the camera gimbal device according to the related art, as the camera 40 is lowered to the lowermost end for shooting, a distance between the camera 40 and each of the yaw-axis motor 10, the pitch-axis motor 20, and the roll-axis motor 30 increases. Accordingly, an error between the camera 40 and each of the yaw-axis motor 10, the pitch-axis motor 20, and the roll-axis motor 30 becomes severe. However, in the stabilizer 100 for camera shooting according to the present disclosure, the camera module 120 is arranged so as to be distributed over the frame 110, and the first and second brushless motors 130 and 140 are provided in the inner space S of the frame 110 so that the camera module 120 may be located close to each of the first and second brushless motors 130 and 140. As the distance between the camera module 120 and each of the first and second brushless motors 130 and 140 decreases, an error between the camera module 120 and each of the first and second brushless motors 130 and 140 may be reduced and thus a stable VR image may be manufactured.

The above-described stabilizer 100 for camera shooting according to the present disclosure may be used by being modified as follows. First, although the stabilizer 100 for camera shooting according to the present disclosure uses the first, second, and third brushless motors 130, 140, and 150, the third brushless motor 150 may be omitted as necessary. In this case, the orthogonal frame 112 is not provided with the third brushless motor 150, and the damper plate 160 is directly coupled to the orthogonal frame 112.

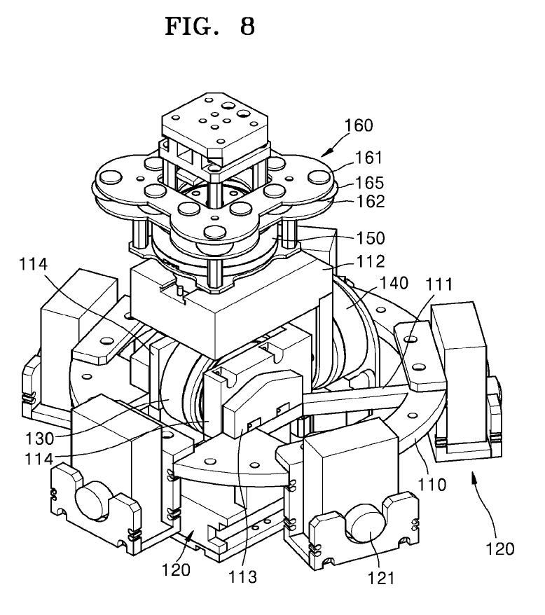

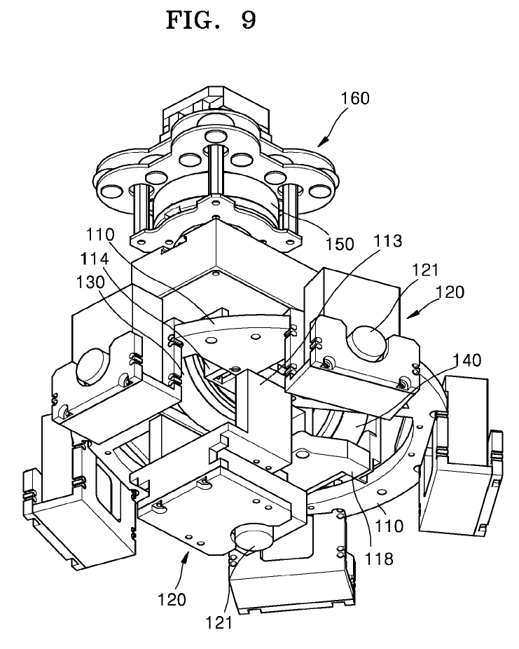

Referring to FIGS. 8 and 9, the stabilizer 100 for camera shooting according to the present disclosure may be modified as follows. Five camera modules 120 may be mounted along the frame 110 and one camera module 120 for capturing an image of the ground may be further provided on a lower portion of the frame 110. The camera module 120 having the lens 121 for capturing an image of the ground may be mounted on a lower frame 113 extending downward from the frame 110 in the Z-axis direction. The lower frame 113 may extend downward directly from the frame 110 in the Z-axis direction, or from the support frame 111 provided in the frame 110.

Furthermore, the fixed frame 114 where the first brushless motor 130 is fixed may be connected to the second brushless motor 140 via a connection frame 118. Although the fixed frame 114 is rotatably coupled to the second brushless motor 140 via the second shaft 141, in this case, it may be difficult to support the weight of the fixed frame 114 and the first brushless motor 130 fixed to the fixed frame 114 with the second shaft 141 only. Accordingly, the fixed frame 114 may be coupled to the second brushless motor 140 via the connection frame 118 extending toward the fixed frame 114. In this case, the connection frame 118 may be rotatably coupled to the second brushless motor 140.

As described above, according to the present disclosure, since the camera module is provided outside the frame, and the brushless motor for correcting the position of the camera module is provided in the inner space of the frame, the distance between the brushless motor and the camera module decreases. Accordingly, the error occurring between the brushless motor and the camera module may be reduced.

Furthermore, according to the present disclosure, as the camera module is provided outside the frame, an image of an unmanned aerial vehicle, a drone, or a human may be prevented from being captured. Accordingly, a size of an image removed to manufacture a VR image may be reduced.

It should be understood that embodiments described herein should be considered in a descriptive sense only and not for purposes of limitation. Descriptions of features or aspects within each embodiment should typically be considered as available for other similar features or aspects in other embodiments.

While one or more embodiments have been described with reference to the figures, it will be understood by those of ordinary skill in the art that various changes in form and details may be made therein without departing from the spirit and scope as defined by the following claims.

What is claimed is:

1. A stabilizer for camera shooting, the stabilizer enabling correction of a position of a camera module and comprising:
a frame having an inner space;
a plurality of camera modules mounted on the frame, each of the plurality of camera modules including a lens for shooting an outside of the frame;
a first brushless motor arranged in the inner space and rotating the frame around a first rotation axis; and
a second brushless motor arranged in the inner space and rotating the frame around a second rotation axis crossing the first rotation axis on a same plane,
wherein the frame is rotatably coupled to the first brushless motor via a first shaft, the frame capable of rotating with respect to the first brushless motor, and
a height of each lens in a Z-axis direction is within a range of a shortest dimension in a transverse direction between the frame and a center of the inner space of the frame with respect to the first shaft.

2. The stabilizer for camera shooting of claim 1, further comprising:
an orthogonal frame extending upward in the Z-axis direction with respect to the frame, and
a third brushless motor mounted on the orthogonal frame and rotating the frame around a third rotation axis crossing the first rotation axis and the second rotation axis on a plane different from a plane formed by the first rotation axis and the second rotation axis.

3. The stabilizer for camera shooting of claim 2, comprising a fixed frame arranged in the inner space and to which the first brushless motor is fixed,
wherein the fixed frame is coupled to the second brushless motor via a second shaft, the fixed frame capable of rotating with respect to the second brushless motor,
the second brushless motor is fixed to the orthogonal frame, and
the orthogonal frame is rotatably coupled to the third brushless motor via a third shaft.

4. The stabilizer for camera shooting of claim 3, wherein the lens is formed on a same plane as the first shaft or the second shaft, or the lens is formed on a same plane as the first shaft and the second shaft.

5. The stabilizer for camera shooting of claim 3, wherein the orthogonal frame or the third shaft is capable of contracting and expanding in a lengthwise direction of the third shaft.

6. The stabilizer for camera shooting of claim 3, further comprising a damper plate, the damper plate comprising:
a fixed member to which the third brushless motor is fixed;
a first plate coupled to the fixed member and having a plurality of first coupling holes;
a second plate spaced apart from the first plate in the Z-axis direction and having a plurality of second coupling holes; and
an elastic member inserted in each of the plurality of first coupling holes and each of the plurality of second coupling holes to connect the first plate and the second plate.

7. The stabilizer for camera shooting of claim 6, further comprising a support rod connected to the damper plate.

8. The stabilizer for camera shooting of claim 1, further comprising a balance weight detachably coupled to the stabilizer for camera shooting.

9. The stabilizer for camera shooting of claim 1, further comprising a lower frame extending downward from the frame in the Z-axis direction,
wherein the camera module is mounted on the frame and the lower frame, and the lens of the camera module mounted on the lower frame captures an image of ground.
